(19) United States
(12) Patent Application Publication
(10) Pub. No.: US 2008/0189331 A1
(43) Pub. Date: Aug. 7, 2008

(54) APPARATUS AND METHOD OF MANAGING CONTENT

(75) Inventors: Ju-Youn LEE, Seongnam-si (KR); Young-Ho Rhee, Seoul (KR); Ja-Yeon Lee, Seoul (KR); Deok-Won Kim, Incheon (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/854,097

(22) Filed: Sep. 12, 2007

(30) Foreign Application Priority Data
Feb. 5, 2007 (KR) 2007-11596

(51) Int. Cl. G06F 17/30

(52) U.S. Cl. 707/104.1; 707/E17.02

(57) ABSTRACT

An apparatus for and a method of managing contents, the apparatus including an inserting unit to insert a mood tag so as to display a user's mood with respect to predetermined content or an importance tag so as to display the importance of the content, a classifying unit to classify the content according to a value of the inserted mood tag or importance tag, and a storing unit to store the classified content and the value of the mood tag or the importance tag that corresponds to the content.

### CROSS-REFERENCE TO RELATED APPLICATION

This application claims the benefit of Korean Application No. 2007-11596, filed Feb. 5, 2007 in the Korean Intellectual Property Office, the disclosure of which is incorporated herein by reference.

### BACKGROUND OF THE INVENTION

1. Field of the Invention

Aspects of the present invention relate to an apparatus and method of managing content, and more particularly, an apparatus and method of managing content that inserts users' moods or levels of importance into the content, and searches or manages the content according to the inserted values.

2. Description of the Related Art

In recent years, mobile communication terminals, such as PDAs (Personal Digital Assistants), PCSs (Personal Communication Systems), and mobile phones, to which cameras are attached, have been widely used. When using the communication terminals, users can transmit and receive text messages and capture images.

Further, as an example of using a mobile communication terminal, a measuring apparatus in the mobile communication terminal measures a user's pulse rate and temperature so as to estimate the user's moods. The estimated mood information is transmitted to a server, and content appropriate with respect to the mood information, such as music or voice messages, is searched in a database of the server and provided to the user. That is, when the user feels depressed, music may be searched through the database of the server and music to make the user feel better is provided to the user.

However, it is difficult to accurately estimate the user's mood on the basis of the user's pulse rate and temperature. Further, there is a limitation in that the service provides uniform content but fails to suit all the different moods of individuals.

### SUMMARY OF THE INVENTION

An aspect of the present invention is to provide an apparatus and method of managing content that inserts a user's moods or a level of importance into content and efficiently searches or manages the content according to the inserted values.

According to an aspect of the present invention, there is a provided an apparatus for managing content, the apparatus including an inserting unit to insert a mood tag so as to display a user's mood with respect to predetermined content or an importance tag so as to display the importance of the content, a classifying unit to classify the content according to a value of the inserted mood tag or importance tag, and a storing unit storing the classified content and the value of the mood tag or the importance tag that corresponds to the content.

According to another aspect of the present invention, there is a provided a method of managing content, the method including inserting a mood tag so as to display a users mood with respect to predetermined content or an importance tag so as to display the importance of the content, classifying the content according to a value of the inserted mood tag or importance tag, and storing the classified content, and the value of the mood tag or the importance tag that corresponds to the content.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent and more readily appreciated by describing in detail embodiments thereof with reference to the accompanying drawings, in which:

FIG. 1 is a block diagram of an apparatus for managing content according to aspects of the present invention;

FIG. 2 is a view illustrating screens through which a mood tag is inserted according to aspects of the present invention;

FIG. 3 is a view illustrating received messages that are classified according to values of mood tags according to aspects of the present invention;

FIG. 4 is a view illustrating screens in which an importance tag is inserted according to aspects of the present invention;

FIG. 5 is a view illustrating screens in which content stored according to tags on the basis of values of the tags are managed according to aspects of the present invention; and

FIG. 6 is a flowchart illustrating a method of managing content according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain aspects of the present invention by referring to the figures.

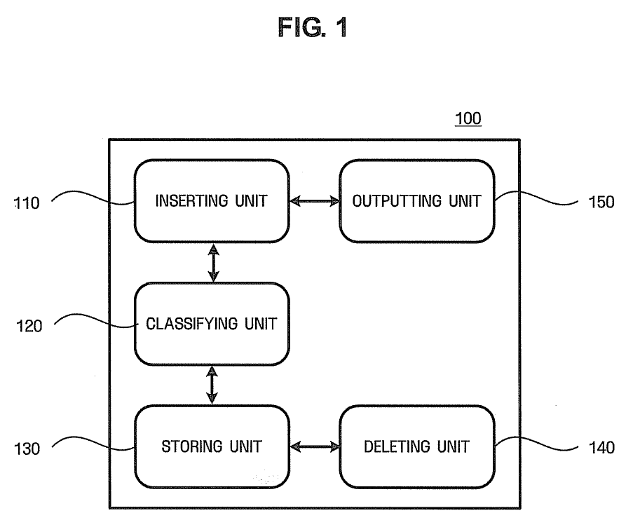

FIG. 1 is a block diagram of an apparatus for managing content 100 according to aspects of the present invention. The apparatus for managing content 100 includes an inserting unit 110, a classifying unit 120, a storing unit 130, a deleting unit 140, and an outputting unit 150. While not shown, the apparatus for managing content 100 can include an interface through which content is transmitted and/or received, and an input device through which text can be entered or user input received. Further, while shown as a common housing, it is understood that ones of the components can be merely connectable to the apparatus and need not be internal to the housing. Although sometimes described herein as a mobile communication terminal, the apparatus for managing content 100 according to aspects of the present invention is not limited thereto such that the apparatus may be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

The inserting unit 110 inserts a mood tag or an importance tag into predetermined content. The mood tag may be used to display a user's mood while the content is in use, and the importance tag may be used to display the importance of the content. The mood tag or the importance tag may be formed of at least one of text, characters, cartoons, and videos, or combinations thereof; however, the mood tag or the importance tag need not be limited thereto. For example, the mood tag or the importance tag may be a color tag. The content into which the tag is inserted may be output onto the screen by the outputting unit 150, to be described below, and provided to the user. Further, the inserting unit 110 may search for a tag corresponding to a received predetermined content and insert the searched tag into the received predetermined content. For example, when a mood tag of a laughing face is inserted into a name, SAMSUNI, of a contact address, and a text message is received from SAMSUNI, the mood tag of the laughing face that corresponds to the received text message is searched and inserted into the text message by the inserting unit 110.

The classifying unit 120 classifies content according to a value of the inserted mood tag or importance tag. Content may be classified according to mood tags or importance tags, and then automatically stored. For example, a mood tag of joy is inserted into content A (here, the mood tag of joy has a value of 1), and the content A is classified and stored according to the value of the mood tag of joy.

Further, the classifying unit 120 may automatically classify the content according to a value of the mood tag or importance tag that is previously inserted with respect to the received content, and then stored. For example, when a mood tag of joy is previously inserted into a name, HONG GIL DONG, of a contact address, the mood tag of the joy is inserted into each piece of content that is received from HONG GIL DONG, and may be output onto the screen by the outputting unit 150, which is to be described below. The content received from HONG GIL DONG may be automatically classified according to the previously inserted mood tags or importance tags and then automatically stored. As such, when the mood tags are individually inserted into the content, the content is classified according to values of the mood tags that are inserted into the content, and the classified content is stored by the storing unit 130, which is to be described below.

The storing unit 130 stores the classified content and the values of the tags inserted into the content. The storing unit 130 may be a storage space, such as various kinds of memories or hard discs. The content may be managed in a database according to the values of the tags. However, the storing unit 130 need not be limited thereto such that the content may be managed on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). The content may be managed locally by the communication terminal or may be managed remotely on a server through a hard wire, Wi-Fi, cellular telephone, wireless internet connection, or any similar connection.

The deleting unit 140 automatically deletes the content when the content stored according to the mood tags or the importance tags exceeds a critical capacity or a critical number. For example, content is classified according to values of mood tags of rage, sorrow, anger, and the like. At this time, when the content classified according to the value of the predetermined mood tag exceeds a critical capacity (i.e., memory space or size) or a critical number (i.e., number of individual content files), the deleting unit 140 may delete the content grouped according to the value of the mood tag. Further, the deleting unit 140 may delete all of the content grouped according to the value of the predetermined mood tag at the same time at a predetermined time. Moreover, the deleting unit 140 may delete content according to the value of the mood tag or the importance tag such that older content is deleted before newer content, or content determined to be less important than other content as indicated by the importance tag is deleted first. The content may be deleted according to the value of the mood tag or the importance tag and time such that older content having a first mood may be retained while new content having a second mood is deleted. Or, any combination of mood, importance, and time may be used to delete or retain content according to the value of the mood tag and/or the importance tag and/or time.

The outputting unit 150 outputs content, into which the mood tag or the importance tag is inserted, on a screen. The outputting unit 150 includes a module having an image display unit that can display an input image signal, such as a CRT (Cathode Ray Tube), an LCD (Liquid Crystal Display), an LED (Light-Emitting Diode), an OLED (Organic Light-Emitting Diode), or a plasma display panel (PDP). However, the outputting unit 150 need not be limited to outputting the content on a screen such that the outputting unit 150 may output content through a speaker, a printable medium, or an electric signal, or can be an external display connected to the apparatus 100.

Each of the components shown in FIG. 1 may be composed of a kind of “module”. The term “module” includes software, or a hardware component such as an FPGA (Field Programmable Gate Array) or an ASIC (Application Specific Integrated Circuit) and the modules each perform allocated functions. However, the modules are not limited to software or hardware. The modules may be configured in an addressable storage medium, or may be configured to run on at least one processor. Therefore, as an example, the modules include: components such as software components, object-oriented software components, class components, and task components; processors, functions, attributes, procedures, sub-routines, segments of program codes, drivers, firmware, microcodes, circuits, data, databases, data structures, tables, arrays, and variables. The functions provided by the components and the modules may be combined into fewer components and or modules may be separated into additional components and modules. It is intended that the processes described herein be broadly interpreted as being equivalently performed by software, hardware, or a combination thereof. As previously discussed, software modules can be written via a variety of software languages, including C, C++, Java, Visual Basic, and many others. These software modules may include data and instructions which can also be stored on one or more machine-readable storage media.

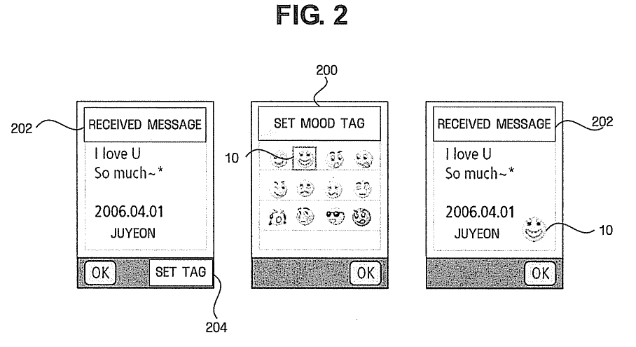

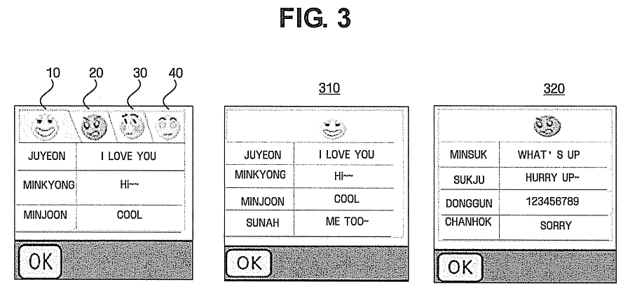

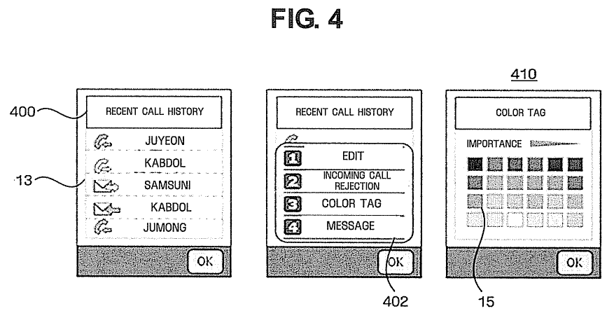

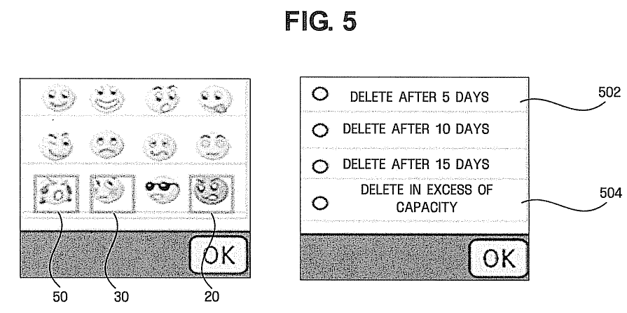

FIG. 2 is a view illustrating screens through which a mood tag is inserted according to aspects of the present invention. A mood tag or an importance tag may be inserted into content. For better understanding, in FIGS. 2 and 3, a mood tag will be mainly described, and in FIGS. 4 and 5, an importance tag will be mainly described. However, the description in FIGS. 2 and 3 is not limited to the mood tag but can be applied to the importance tag. In the same way, the description in FIGS. 4 and 5 is not limited to the importance tag but can be applied to the mood tag.

As shown in FIG. 2, the user inserts a mood tag or an importance tag into content (such as text messages, telephone numbers, pictures, videos, music, and the like) which are provided in a mobile communication terminal so that the user can manage the content according to a value of the inserted tag.

First, when the user clicks a tag inserting button 204 on a screen 205 on which a received message 202 is displayed, a screen 200 in which a mood tag can be inserted is provided. A plurality of mood tags in the form of text, characters, cartoons, and videos, or combinations thereof may be provided on the screen 200 through which the mood tag to be inserted is selected.

When the user selects a mood tag that expresses a user's mood (i.e., a joy mood tag 10), the inserting unit 110 inserts the joy mood tag 10 into the received message 202 and outputs the received message 202 with the mood tag 10 on a screen 210.

At this time, when the joy mood tag 10, which expresses joy, has a value of 1, the received message 202 and the value 1, which is the value of the mood tag inserted into the received message 202, may be stored together in the storing unit 130. When the received message 202 and the value (i.e. 1 for the inserted joy mood tag 10) are stored, the content may be classified and stored according to the value of the inserted tag by the classifying unit 120. This will be described in more detail with reference to FIG. 3. Although no shown, the user may select more than one mood tag to be inserted by the inserting unit 110 into the received message 202 so that the received message 202 may be classified according to the values of the inserted tags by the classifying unit 120.

FIG. 3 is a view illustrating received messages that are classified according to values of mood tags according to aspects of the present invention. As shown in FIG. 3, the content may be classified and stored according to the mood tags.

Received messages may be classified and stored according to values of the mood tags that are inserted into the messages. For example, when mood tags of joy 10, anger 20, sorrow 30, and embarrassment 40 are inserted into content, respectively, the content may be classified and stored according to values of the inserted mood tags, and the classified content may be output onto a screen 305 and provided to the user.

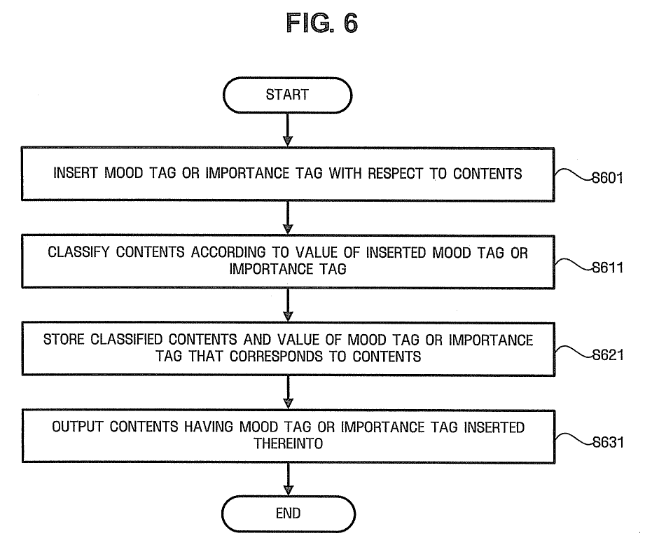

When the joy mood tag 10 is selected, the received messages grouped according to the value of the selected joy mood tag 10 are output onto a screen 310. In the same way, when an anger mood tag 20 is selected, the received messages grouped according to the value of the selected anger mood tag 20 are output onto a screen 320. Further, when the content stored according to the mood tags exceed a critical capacity or a critical number, the content may be automatically deleted by the deleting unit 140. At this time, the user may insert a predetermined mood tag to which automatic deletion is applied. This will be described below with reference to FIG. 6.

Meanwhile, the user may insert an importance tag according to the importance of contact addresses (or names), which will now be described with reference to FIG. 4. Although the importance tag may be inserted according to the importance of the contact addresses or the names, the importance tag is not limited thereto such that the importance tags may be inserted with respect to groups of names or friends or be inserted according to specified words contained in a received message. FIG. 4 is a view illustrating screens through which an importance tag is inserted according to aspects of the present invention. For example, a name, SAMSUNI 13, is selected from a recent call history 400 displayed on a screen 403. Upon selection of the name SAMSUNI 13, a menu is displayed on a screen 405 from which a color tag menu 402 is selected so as to insert an importance tag. The menu displayed on the screen 405 may include other options such as edit contact information, reply to message, or the like. The importance tags may have different values assigned thereto according to displayed colors; for example, the importance tag may have a maximum value of 10 corresponding to a color red and a minimum value of 0 corresponding to a color blue.

On a screen 410 through which a color tag is selected, the user may select a red color 15 so as to insert an importance tag with respect to the name SAMSUNI 13 so as to identify a source of the content. Since the inserted importance tag has the red color 15, the maximum value of 10 may be stored in the storing unit 130. Further, according to aspects of the current invention, an RGB color value, FF0000, which corresponds to the red color 15, may be stored. Although described as the user identifying the name as the source of the content, the source is not limited thereto such that phone numbers, IP addresses, email addresses, or any other sending device identifier may be selected to identify the source of the content.

After having inserted the importance tag with respect to the name SAMSUNI 13, when the user receives content, such as a call or a text message, from the name SAMSUNI 13, the red color 15, is inserted into the content and output onto the screen. As such, the importance tag was previously determined to correspond to the name SAMSUNI 13 so that when additional content is received corresponding to the name SAMSUNI 13, the inserting unit 110 of FIG. 1 inserts the previously determined tag to into the content received from the name SAMSUNI 13. Again, the source of the content may be identified by a phone number, an IP address, an email address, or the like. As such, when the user receives the content during a meeting or while on an urgent job, the importance tag inserted into the received content helps the user determine whether or not to check the corresponding content. The corresponding content is classified by the classifying unit 120 and stored by the storing unit 130, both as shown in FIG. 1, according to the value of the inserted importance tag.

Meanwhile, the user may collectively delete the content classified according to the mood tags or the importance tags or insert the mood tag or the importance tag such that the content are deleted after a predetermined period of time. FIG. 5 is a view illustrating screens in which content stored according to tags (on the basis of the values of the tags) is managed according to aspects of the present invention. As shown in FIG. 5, the user selects one of or several predetermined mood tags from a screen 505, and can collectively delete content grouped according to the selected predetermined mood tag or set a time when the content is automatically deleted. When the time of deleting the content is determined as selected from a screen 510, it is possible to delete all of the content stored according to the selected mood tag at the same time. In this way, content can be deleted at different rates according to each mood tag or can be deleted collectively at a same time at a preset event. Hereinafter, this will be described in detail by using an example. Although deleting the content according to a selected time is described in association with a mood tag, the deleting the content is not limited thereto such that the content may be deleted according to a selected time and an importance tag. Further, although the screen 510 is shown to have predetermined selections, the screen 510 is not limited thereto such that the screen 510 may allow for entry of a time period after which the content associated with the selected mood tags is deleted.

Continuing in FIG. 5, the user selects the rage mood tag 50, the sorrow mood tag 30, and the anger mood tag 20. Then, the user sets a time to delete, i.e., delete after 5 days 502. After 5 days (as selected by the delete after 5 days 502), content classified and stored according to values of the rage mood tag 50, the sorrow mood tag 30, and the anger mood tag 20 are deleted at the same time by the deleting unit 140 of FIG. 1. However, remaining tags are not selected and are thus separately managed for deletion.

If the time is set to delete content according to capacity, the delete in excess of capacity 504 is selected from the screen 510, such that when the content classified and stored according to the values of the mood tags of the rage mood tag 50, the sorrow mood tag 30, and the anger mood tag 20 exceed a critical capacity or a critical number, the content can automatically be deleted by the deleting unit 140. The critical capacity may be a predetermined amount of memory associated with the user device or a portion thereof. Further, the critical capacity or critical number may be associated respectively or collectively with the selected mood tags (i.e., the rage mood tag 50, the sorrow mood tag 30, and the anger mood tag 20).

Therefore, content that the user does not want to retain or content that is not important is periodically deleted automatically such that a storage space in the device is automatically secured, and convenience of managing content can be provided to the user.

Although the selecting of multiple mood tags for manipulation of the content with respect to deletion is discussed, aspects of the present invention are not limited thereto such that multiple (or individual) mood tags may be selected to receive a message or content from the user. For example, the user may select the joy mood tag 10 of FIG. 3 and send a message in response to all of the messages that are stored according to the value of the joy mood tag 10 or send a message to all identified sources associated with the joy mood tag 10 as could be inserted in FIG. 4.

FIG. 6 is a flowchart illustrating a method of managing content according to aspects of the present invention. The inserting unit 110 inserts a mood tag so as to display a user's mood with respect to predetermined content or an importance tag so as to display the importance of the content (Operation S601). The operation S601 may be user defined or automatic when the mood tag or the importance tag has been previously defined by the user as described above. The classifying unit 120 classifies the content according to a value of the inserted mood tag or importance tag (Operation S611). The storing unit 130 stores the classified content; and the value of the mood tag or the importance tag that corresponds to the content (Operation S621). At this time, when the content stored according to the mood tag or the importance tag exceeds a critical capacity or a critical number, the deleting unit 140 automatically deletes the content.

The outputting unit 150 outputs the content into which the mood tag or the importance tag is inserted on the screen, and provides the user with the content having the mood tag or the importance tag inserted thereto (Operation S631).

As described above, according to aspects of the apparatus and method of managing content according to aspects of the present invention, the following and/or other effects may be obtained: It is possible to recognize the importance of content before taking the time necessary to independently evaluate the content upon receipt of the content. It is also possible to manage content according to moods as defined by a user. Further, unnecessary content is deleted at a same time according to a predetermined period such that a storage space in the device can be automatically secured.

Although aspects of the present invention have been shown and described, it would be appreciated by those skilled in the art that changes may be made in this embodiment without departing from the principles and spirit of the invention, the scope of which is defined in the claims and their equivalents.

1. An apparatus for managing content, the apparatus comprising:
an inserting unit to insert a tag so as to display information with respect to the content, the tag being selectable between a mood tag and an importance tag, the mood tag being selectable between a plurality of moods of a user, and the importance tag being selectable between a plurality of importance levels to indicate a relative importance to the user;
a classifying unit to classify the content according to a value of the inserted tag; and
a storing unit to store the classified content and the value of the inserted tag that corresponds to the content according to the value of the inserted tag.

2. The apparatus of claim 1, further comprising:
an outputting unit to output the content into which the mood tag or the importance tag is inserted to a screen organized according to a selected one of the mood tags and importance tags.

3. The apparatus of claim 1, further comprising:
a deleting unit to delete the content when the content stored according to the value of the mood tag or the importance tag exceeds a critical capacity or a critical number.

4. The apparatus of claim 1, wherein the tag is formed of at least one of text, characters, cartoons, and video, or combinations thereof.

5. The apparatus of claim 1, wherein the tag is a displayed color.

6. The apparatus of claim 1, further comprising:
a deleting unit to delete the content after a determined period of time.

7. The apparatus of claim 6, wherein the user determines the period of time.

8. The apparatus of claim 1, further comprising:
a deleting unit to delete the content according to both a mood tag and an importance tag in combination.

9. A method of managing content, the method comprising:
inserting a tag into the content, the tag being selectable between a mood tag and an importance tag, the mood tag being selectable between a plurality of moods of a user, and the importance tag being selectable between a plurality of importance levels to indicate a relative importance to the user;
classifying the content according to a value of the inserted tag; and
storing the classified content and the value of the inserted tag that corresponds to the content according to the value of the inserted tag.

10. The method of claim 9, further comprising:
outputting the content into which the tag is inserted to a screen organized according to the mood tags or importance tags.

11. The method of claim 9, further comprising:
deleting the content when the content stored according to the value of the tag exceeds a critical capacity or a critical number.

12. The method of claim 9, wherein the tag is formed of at least one of text, characters, cartoons, and videos, or combinations thereof.

13. The method of claim 9, wherein the tag is represented as a color.

14. The method of claim 9, further comprising:
deleting the content after a determined period of time.

15. A computer-readable medium encoded with processing instructions implementing the method of claim 9 performed by a computer.

16. A method of managing content, the method comprising:
identifying a source from which the content is received;
inserting a tag into the content, the tag being selectable between a mood tag and an importance tag, the mood tag being selectable between a plurality of moods of a user, and the importance tag being selectable between a plurality of importance levels to indicate a relative importance to the user;
classifying the content according to a value of the inserted tag; and
storing the classified content and the value of the inserted tag that corresponds to the content according to the value of the inserted tag,
wherein the inserting the tag comprises inserting a tag previously selected to correspond to the identified source.

17. The method of claim 16, wherein the identifying the source comprises recognizing a name having the previously selected tag corresponding thereto.
